(19) United States
(12) Patent Application Publication
(10) Pub. No.: US 2025/0005892 A1
(43) Pub. Date: Jan. 2, 2025

(54) METHOD FOR POSITIONING AND TRACKING, APPARATUS, TERMINAL DEVICE, AND COMPUTER-READABLE STORAGE MEDIUM

(71) Applicant: GOERTEK INC., Weifang (CN)

(72) Inventors: Yali SUN, Weifang (CN); Xiao Bao, Weifang (CN)

(21) Appl. No.: 18/884,575

(22) Filed: Sep. 13, 2024

Related U.S. Application Data
(63) Continuation of application No. PCT/CN2022/102357, filed on Jun. 29, 2022.

(30) Foreign Application Priority Data
Jun. 14, 2022 (CN) 202210667956.1

(51) Int. Cl. G06V 10/60; G06V 20/20

(52) U.S. Cl. CPC G06V 10/60; G06V 20/20; G06V 2201/07

(57) ABSTRACT

Disclosed are a method for positioning and tracking, an apparatus, a terminal device, and a computer-readable storage medium. The method includes: capturing an image containing a plurality of light spots by the image acquisition device; the plurality of light spots are generated by each of multiple light sources on the handle emitting invisible light; determining first identification data of target light sources corresponding to the plurality of light spots in the image in the multiple light sources; determining a positional relationship between a plurality of the target light sources according to the first identification data, and calculating a first distance parameter between the handle and the VR head-mounted device according to the positional relationship; and converting the first distance parameter into a spatial coordinate of the handle to perform positioning and tracking of the handle.

### CROSS-REFERENCE TO RELATED APPLICATIONS

The present application is a continuation application of International Application No. PCT/CN2022/102357, filed on Jun. 29, 2022, which claims priority to Chinese patent application No. 202210667956.1, entitled in “METHOD FOR POSITIONING AND TRACKING, APPARATUS, TERMINAL DEVICE, AND COMPUTER READABLE STORAGE MEDIUM” and filed on Jun. 14, 2022. The disclosures of the above-mentioned applications are incorporated herein by reference in their entireties.

### TECHNICAL FIELD

The present application relates to the technical field of virtual reality, and in particular to a method for positioning and tracking, an apparatus, a terminal device, and a computer-readable storage medium.

### BACKGROUND

With the rapid development of virtual reality (VR) devices, the accuracy of handle tracking and the updating of positioning information have become increasingly important for VR devices.

Currently, the main methods for tracking handles in VR device are electromagnetic positioning and optical positioning. Among them, electromagnetic method for positioning and tracking has poor anti-interference properties of magnetic fields, and the higher the accuracy requirements, the greater the power consumption, causing the handles to heat up and thus affecting positioning accuracy. In addition, the main methods for tracking the handle through optics include laser positioning and visible light positioning. Laser positioning mainly involves setting up a laser transmitting device and a laser receiving device. The handle is tracked and positioned through the reception and emission of laser, while regarding to positioning through visible light, the position of the handle is mainly located by extracting the characteristics of visible light. However, the method of laser positioning is costly and is not suitable for VR head-mounted devices. When positioning the handle through visible light, it is easily affected by other visible light in the surrounding environment, which can lead to the relatively high positioning delay for the handle.

### SUMMARY

By providing a method for positioning and tracking, an apparatus, a terminal device and a computer-readable storage medium, the embodiments of the present application aim to improve the refresh frequency and accuracy of positioning and tracking of handles by VR head-mounted devices without increasing costs.

In order to achieve the above purpose, embodiments of the present application provide a method for positioning and tracking; the method for positioning and tracking is applied to a virtual reality (VR) head-mounted device equipped with an image acquisition device to perform positioning and tracking of a handle, and the handle is equipped with multiple light sources; the method includes:

capturing an image containing a plurality of light spots by the image acquisition device; the plurality of light spots are generated by each of multiple light sources on the handle emitting invisible light;

determining first identification data of target light sources corresponding to the plurality of light spots in the image in the multiple light sources;

determining a positional relationship between a plurality of the target light sources according to the first identification data, and calculating a first distance parameter between the handle and the VR head-mounted device according to the positional relationship; and

converting the first distance parameter into a spatial coordinate of the handle to perform positioning and tracking of the handle.

In an embodiment, the determining the first identification data of the target light sources corresponding to the plurality of light spots in the image in the multiple light sources includes:

detecting characteristic data of each of the plurality of light spots, and obtaining action data of the handle;

combining multiple characteristic data and action data to obtain combined data, and compare multiple combined data with light spot characteristic data in a preset offline characteristic database to obtain a comparison result; and

determining the first identification data of the target light source corresponding to each of the plurality of light spots in the multiple light sources according to the comparison result.

In an embodiment, the determining the first identification data of the target light source corresponding to each of the plurality of light spots in the multiple light sources according to the comparison result includes:

in response to that the comparison result is that the combined data is similar to the light spot characteristic data, then determining the second identification data of each of the multiple light sources associated with the light spot characteristic data as the first identification data of the target light source corresponding to each of the multiple light spots.

In an embodiment, the method for positioning and tracking further includes:

in response to that the handle performs any action and moves, capturing a second image containing the plurality of light spots by the image acquisition device; and

constructing the offline characteristic database by combining the characteristic data of the plurality of light spots in the second image with the action data generated during a movement of the handle.

In an embodiment, the light sources are arranged on the handle according to preset arrangement rules, and the determining the positional relationship between the plurality of the target light sources according to the first identification data includes:

obtaining the arrangement rules; and

determining the positional relationship of the target light sources corresponding to the plurality of light spots respectively in the multiple light sources according to the arrangement rules.

In an embodiment, the calculating the first distance parameter between the handle and the VR head-mounted device according to the positional relationship includes:

calculating a second distance parameter between each of the plurality of target light sources and the image acquisition device based on the positional relationship; and

calculating an average value for a plurality of second distance parameters, and configuring a calculated average value as the first distance parameter between the handle and the VR head-mounted device.

In an embodiment, the converting the first distance parameter into the spatial coordinate of the handle to perform positioning and tracking of the handle includes:

determining first coordinates of each of the plurality of target light sources relative to the image acquisition device;

converting a plurality of first coordinates into the second coordinates of each of the plurality of target light sources in 3D space; the 3D space is the 3D space displayed by the VR head-mounted device; and

converting a plurality of second coordinates into third coordinates of a cohesion point of the handle in the 3D space, and configuring the third coordinates as spatial coordinates of the handle in the 3D space.

In order to achieve the above purpose, the present application also provides an apparatus for positioning and tracking, including:

an acquisition module, configured to capture an image containing a plurality of light spots through an image acquisition device; the plurality of light spots are generated by each of multiple light sources emitting invisible light on a handle;

a determination module, configured to determine first identification data of target light sources corresponding to the plurality of light spots in the image in the multiple light sources;

a calculation module, configured to determine a positional relationship between a plurality of target light sources according to the first identification data, and calculate a first distance parameter between the handle and a VR head-mounted device according to the positional relationship; and

a conversion module, configured to convert the first distance parameter into a spatial coordinate of the handle to position and track the handle.

In order to achieve the above purpose, the present application also provides a terminal device, including: a memory, a processor, and a positioning and tracking program stored on the memory and executable on the processor; the positioning and tracking program is configured to implement the steps of the method for positioning and tracking.

In order to achieve the above purpose, the present application also provides a computer-readable storage medium; a positioning and tracking program is stored on the computer-readable storage medium; when the positioning and tracking program is executed by a processor, the steps of the method for positioning and tracking are implemented.

The method for positioning and tracking provided in the embodiment of the present application is applied to a VR head-mounted device equipped with an image acquisition device to perform positioning and tracking on a handle. The handle is equipped with multiple light sources. The method includes: capturing an image containing a plurality of light spots by the image acquisition device; the plurality of light spots are generated by each of multiple light sources on the handle emitting invisible light; determining first identification data of target light sources corresponding to the plurality of light spots in the image in the multiple light sources; determining a positional relationship between a plurality of the target light sources according to the first identification data, and calculating a first distance parameter between the handle and the VR head-mounted device according to the positional relationship; and converting the first distance parameter into a spatial coordinate of the handle to perform positioning and tracking of the handle.

In this embodiment, the present application uses a VR head-mounted device equipped with an image acquisition device to position and track the handle. The VR head-mounted device uses the image acquisition device to capture an image containing a plurality of light spots when multiple light sources on the handle each emit invisible light; and then the VR head-mounted device determines the first identification data of the target light source corresponding to each of the plurality of light spots in the image among the multiple light sources configured on the handle, and further determines the positional relationship between the plurality of target light sources based on the first identification data, so as to calculate the first distance parameter between the handle and the VR head-mounted device based on the positional relationship; finally, the first distance parameter is converted into the spatial coordinates in the 3D world of the handle displayed on the VR head-mounted device, to complete the positioning and tracking of the handle.

In this way, compared with the existing way of positioning and tracking the handle of VR head-mounted devices, the present application obtains images containing multiple light spots to determine the identification data of the light sources corresponding to the multiple light spots in the multiple light sources, calculates the distance between each light source and the image acquisition device based on the identification data, and then converts the distance into the coordinates of the handle in the 3D space, thereby achieving the effect of positioning and tracking the handle with high positioning accuracy and a high refresh rate, and improving the user experience of using a VR head-mounted device.

### BRIEF DESCRIPTION OF THE DRAWINGS

In order to explain the embodiments of the present application or the technical solutions in the related art more clearly, the drawings needed to be used in the description of the embodiments or the related art will be briefly introduced below. Obviously, the drawings in the following description are only some embodiments of the present application. For those skilled in the art, other drawings can be obtained based on the structures shown in these drawings without exerting creative efforts.

FIG. 1 is a schematic structural diagram of a terminal device of a hardware operating environment according to an embodiment of the present application.

FIG. 2 is a schematic flowchart of a method for positioning and tracking according to an embodiment of the present application.

FIG. 3 is a schematic diagram of an arrangement of infrared lamp beads on a handle involved in the method for positioning and tracking according to an embodiment of the present application.

FIG. 4 is a schematic diagram of a monocular ranging principle involved in the method for positioning and tracking according to an embodiment of the present application.

FIG. 5 is a schematic diagram of an application process involved in the method for positioning and tracking according to an embodiment of the present application.

FIG. 6 is a schematic diagram of another application process involved in the method for positioning and tracking according to an embodiment of the present application.

FIG. 7 is a schematic diagram of functional modules involved in the method for positioning and tracking according to an embodiment of the present application.

The realization of the purpose, functional features and advantages of the present application will be further described with reference to the embodiments and the accompanying drawings.

### DETAILED DESCRIPTION OF THE EMBODIMENTS

It should be understood that the specific embodiments described here are only configured to explain the present application and are not configured to limit the present application.

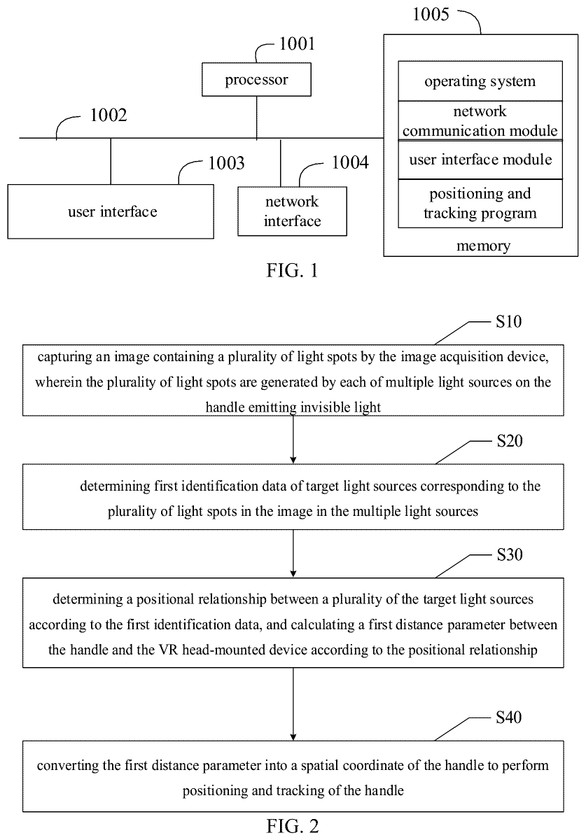

Referring to FIG. 1, FIG. 1 is a schematic structural diagram of a terminal device of the hardware operating environment involved in the embodiment of the present application.

The terminal device involved in the embodiment of the present application may be a mobile VR head-mounted device or a fixed VR head-mounted device. The mobile VR head-mounted device or the fixed VR head-mounted device has a matching handle, and the handle is configured with multiple light sources for emitting invisible light.

As shown in FIG. 1, the terminal device may include: a processor 1001, such as a central processing unit (CPU), a communication bus 1002, a user interface 1003, a network interface 1004, and a memory 1005. Among them, the communication bus 1002 is configured to realize connection communication between these components. The user interface 1003 may include a display and an input unit such as a keyboard. The optional user interface 1003 may also include a standard wired interface and a wireless interface. The network interface 1004 may optionally include a standard wired interface or a wireless interface (such as a wireless fidelity (WI-FI) interface). The memory 1005 can be a high-speed random access memory (RAM) or a stable non-volatile memory (NVM), such as a disk memory. The memory 1005 may optionally be a storage device independent of the aforementioned processor 1001.

Those skilled in the art can understand that the structure shown in FIG. 1 does not constitute a limitation on the terminal device, and may include more or fewer components than shown, or combine certain components, or arrange different components.

As shown in FIG. 1, the memory 1005 as a storage medium may include an operating system, a data storage module, a network communication module, a user interface module, and a positioning and tracking program.

In the terminal device shown in FIG. 1, the network interface 1004 is mainly used for data communication with other devices; the user interface 1003 is mainly used for data interaction with the user; the processor 1001 and the memory 1005 in the terminal device of the present application can be set in the terminal device; the device calls the positioning and tracking program stored in the memory 1005 through the processor 1001, and executes the method for positioning and tracking provided by the embodiment of the present application.

Based on the above terminal device, various embodiments of the method for positioning and tracking of the present application are provided.

Please referring to FIG. 2, which is a schematic flow chart of the first embodiment of the method for positioning and tracking of the present application.

The method for positioning and tracking of the present application is applied to a VR head-mounted device equipped with an image acquisition device to perform positioning and tracking of a handle. The handle is equipped with multiple light sources. In this embodiment, the method for positioning and tracking of the present application may include:

Step S10: capturing an image containing a plurality of light spots through the image acquisition device; the plurality of light spots are generated by each of multiple light sources emitting invisible light on the handle;

In this embodiment, during the operation of the terminal device, multiple light sources configured on the handle matched with the terminal device each emit invisible light, and the terminal device captures images including multiple spots produced by the multiple light sources emitting invisible light on the handle through the built-in image acquisition device.

For example, when a VR head-mounted device is running, multiple infrared lamp beads configured on a handle matched with the VR head-mounted device each emit infrared light, and the VR head-mounted device captures a single frame image containing the light spot through a built-in infrared camera. The multiple infrared lamp beads on the handle each emit the infrared light to generate the light spot.

Step S20: determining the first identification data of the target light sources corresponding to the plurality of light spots in the image in the multiple light sources;

In this embodiment, the terminal device recognizes the characteristic data of the multiple light spots in the above-mentioned image, retrieves the action data generated during the movement of the above-mentioned handle, and combines the characteristic data and the action data to obtain the combined result. The obtained combined data is compared with the light spot characteristic data in the preset offline characteristic database, so as to determine the identification data of the target light sources corresponding to the multiple light spots in the image among the multiple light sources.

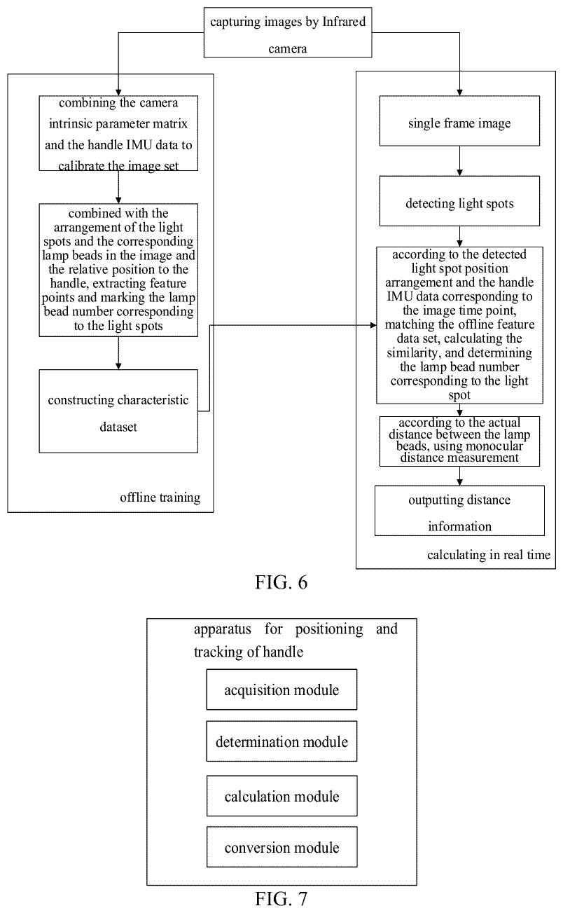

Illustratively, for example, please referring to FIG. 6, the VR head-mounted device detects the number of light spots in the above image, the pixel size of each of the multiple light spots, and the shape characteristic data composed of the multiple light spots through a computer vision algorithm. At the same time, the VR head-mounted device calls the inertial measurement unit (IMU) device in the above-mentioned handle to collect the action data composed of the rotation angle data and acceleration data generated during the movement of the handle; the characteristic data is combined with the action data, and the combined data is compared with the light spot characteristic data in the user's preset offline characteristic database to determine the number of the target infrared lamp bead corresponding to the multiple light spots in the image among the multiple infrared lamp beads on the handle.

Furthermore, in another feasible embodiment, before the above step S20, the method for positioning and tracking of the present application also includes:

Step A: when the handle is moving by performing any action, capturing a second image containing multiple light spots through the image acquisition device;

In this embodiment, when the handle is performing any action and moving, the VR head-mounted device calls the image acquisition device to capture a second image containing multiple light spots generated during the movement of the handle;

Step B: combining the characteristic data of the plurality of light spots in the second image with the action data generated during the movement of the handle to construct the offline characteristic database.

In this embodiment, the VR head-mounted device combines the action data generated when the handle performs any action and the characteristic data of all light spots in the second image to construct an offline characteristic database, and makes the offline characteristic database contain all the light spot characteristic data generated by each light source in the handle when the handle performs any action and moves.

Illustratively, for example, please referring to FIG. 6, when the above-mentioned handle performs any action and moves, the VR head-mounted device calls the above-mentioned infrared camera to capture the second image containing multiple light spots generated by the infrared light emitted by each infrared lamp bead on the handle during the movement of the handle, and combines the action data generated by the handle during the movement with all the characteristic data of each light spot in the image to build an offline characteristic database. The VR head-mounted device makes the offline characteristic database contain characteristic data of all light spots generated by each infrared lamp bead in the handle when the handle performs any action and moves.

It should be noted that, in this embodiment, before the VR head-mounted device acquires the above image, it is necessary to calibrate that the camera frequency of the above-mentioned infrared camera configured in the VR head-mounted device and the frequency of the above action data generated during the IMU device in the above-mentioned handle collecting the movement of the handle is consistent, so that the timestamp of the photo taken by the infrared camera is the same as the timestamp of the action data of the handle collected by the IMU device.

Further, in a feasible embodiment, the above step S20 may specifically include:

Step S201: detecting the characteristic data of each of the plurality of light spots, and obtaining the action data of the handle;

In this embodiment, the terminal device detects the pixel sizes of the multiple light spots in the above-mentioned image and the shape characteristic data composed of the multiple light spots. At the same time, the terminal device calls the sensing device in the above-mentioned handle to detect and obtain the action data containing rotation angle data and acceleration data generated during the movement of the handle.

Step S202: combining multiple characteristic data and action data to obtain combined data, and comparing multiple combined data with spot characteristic data in a preset offline characteristic database to obtain a comparison result;

In this embodiment, the terminal device combines the above-mentioned plurality of characteristic data and the above-mentioned action data to obtain the combined data of the light spot characteristics generated by the multiple light sources on the handle when the above-mentioned handle moves according to the action data, and compares the similarity between the combined data and the spot characteristic data in the user's preset offline characteristic database to obtain a comparison result.

Step S203: determining the first identification data of the target light source corresponding to each of the plurality of light spots in the multiple light sources according to the comparison result.

In this embodiment, the terminal device can determine the first identification data of the target light sources corresponding to the multiple light spots in the image among the multiple light sources on the handle based on whether the combined data and the spot characteristic data are similar in the comparison.

Illustratively, for example, the VR head-mounted device calculates the shape characteristic data of each of the plurality of light spots in the above-mentioned image through a computer vision algorithm preset by the user. At the same time, the VR head-mounted device calls the IMU device configured in the above-mentioned handle to detect and obtain the action data generated during the movement of the handle. After that, the VR head-mounted device combines the above characteristic data and the above action data to obtain the combined data of the features of multiple light spots generated by the multiple infrared lamp beads on the handle when the handle moves according to the above action data. The VR head-mounted device compares the combined data with the light spot characteristic data in the user's preset offline characteristic database, uses whether the combined data is similar to the light spot characteristic data as the comparison result of the above comparison, and determines the number of the target infrared lamp bead corresponding to the multiple light spots in the above image among the multiple infrared lamp beads on the handle based on the comparison result.

Further, in a feasible embodiment, the above step S203 may specifically include:

Step S2031: if the comparison result is that the combined data is similar to the light spot characteristic data, determining the second identification data of the multiple light sources associated with the light spot characteristic data as the first identification data of the target light source corresponding to each of the multiple light spots.

In this embodiment, if the terminal device compares the shape characteristic data composed of light spots in the above combined data to be similar to the corresponding light spot characteristic data in the above offline characteristic database, then the terminal device will determine the second identification data of each of the multiple light sources associated with the light spot characteristic data as the first identification data of the target light source corresponding to each of the light spots in the above image.

For example, if the VR head-mounted device determines that the shape features of each light spot in the combined data are similar to the light spot characteristic data formed when the handle moves under the action data in the user's preset offline characteristic database, then the VR head-mounted device determines the respective numbers of the multiple infrared lamp beads associated with the light spot characteristic data as the numbers of the target infrared lamp beads corresponding to each light spot in the above image.

Step S30: determining the positional relationship between the plurality of target light sources according to the first identification data, and calculating the first distance parameter between the handle and the VR head-mounted device according to the positional relationship;

In this embodiment, the terminal device determines the positional relationship between the target light sources according to the first identification data of the target light sources corresponding to the multiple light spots and the arrangement rules preset by the user. After that, the terminal device calculates to obtain the first distance parameter between the handle and the terminal device through the algorithm preset by the user combined with the positional relationship.

Illustratively, for example, please referring to FIG. 4, the VR head-mounted device determines the distance and angle between the corresponding target infrared lamp beads of the multiple light spots mentioned above among the multiple infrared lamp beads according to the number of the target infrared lamp beads corresponding to each of the multiple light spots in the multiple infrared lamp beads, and the arrangement rule of the infrared lamp beads preset by the user on the handle. Finally, the VR head-mounted device, based on the user's preset monocular ranging formula D=(F*W)/P, calculates the respective distances between each target infrared lamp bead and the infrared camera configured in the VR head-mounted device, calculates the average of the above distances, and finally marks the result of the calculation as the first distance parameter between the handle and the infrared camera.

Further, in a feasible embodiment, the above step S30 may specifically include:

Step S301: obtaining the arrangement rules;

In this embodiment, the terminal device obtains the arrangement rules of each light source on the handle by reading the data stored by the user including the arrangement position of each light source in the handle and the numbering of each light source according to the arrangement position.

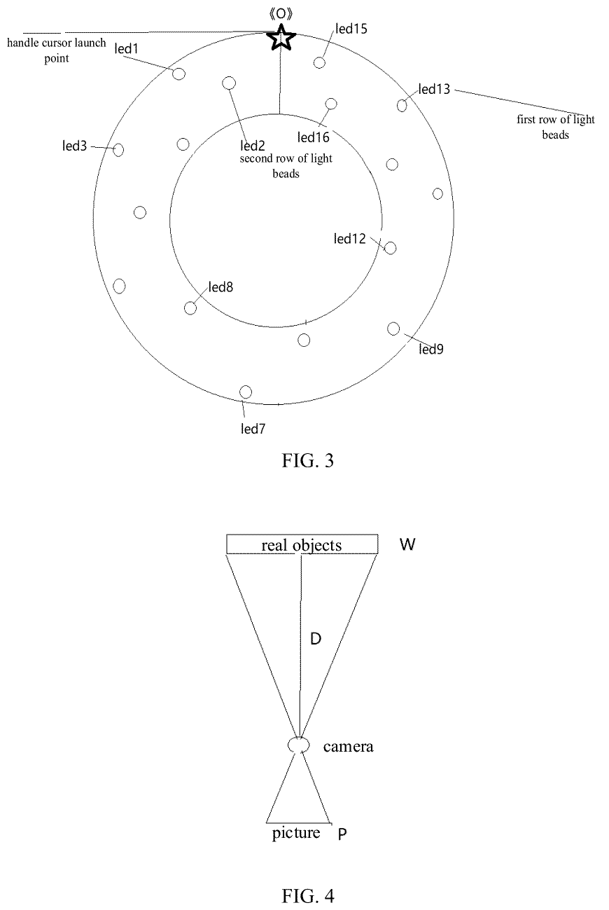

It should be noted that, please referring to FIG. 3, in this embodiment, the arrangement rules of the above-mentioned handle are: the first row of infrared lamp beads of the handle are numbered in odd numbers, such as from LED1 to LED15. Correspondingly, the second row of infrared lamp beads of the handle are numbered evenly, such as from LED2 to LED16; the arrangement rules of the infrared lamp beads on the handle are: the infrared lamp beads are arranged in two rows up and down on the ring at the front of the handle, and during the process of arranging the infrared lamp beads, the other infrared lamp beads are distributed unevenly, mainly concentrated at both ends and scattered in the middle. Each infrared lamp bead in the above-mentioned second row must be distributed crosswise between the above-mentioned first row of infrared lamp beads, forming a triangular distribution.

Step S302: determining the positional relationship of the target light sources corresponding to the plurality of light spots in the multiple light sources according to the arrangement rules;

In this embodiment, after the terminal device obtains the above arrangement rules, it obtains the positional relationship data in the above image consisting of the distances and angles between the corresponding target light sources of the multiple light spots in the multiple light sources according to the arrangement rules.

Step S303: calculating the second distance parameter between each of the multiple light sources and the image acquisition device based on the position relationship;

In this embodiment, the terminal device calculates the respective distances between the target light sources and the image acquisition device according to the algorithm preset by the user combined with the positional relationship data between the target light sources, and marks each of the distances as the second distance parameter.

Step S304: calculating an average value of a plurality of second distance parameters, and using the calculated average value as the first distance parameter between the handle and the VR head-mounted device.

In this embodiment, the terminal device calculates the average value of each of the above-mentioned second distance parameters, marks the average result of each second distance parameter as the distance parameter between the above-mentioned handle and the terminal device, and marks the distance parameter as the first distance parameter between the handle and the terminal device.

For example, the VR head-mounted device obtains the arrangement rules including the method of each infrared lamp bead on the handle by reading the user-stored arrangement position of each infrared lamp bead in the handle and the method of numbering each infrared lamp bead according to the arrangement position, so as to determine the positional relationship data in the above image consisting of the distance and angle between the respective target infrared lamp beads of each light spot in the plurality of infrared lamp beads. And then, the VR head-mounted device combines the position relationship data and calculates the distance parameter D between each infrared lamp bead and the infrared camera according to the user's preset monocular distance measurement formula D=(F*W)/P. At the same time, the VR head-mounted device marks the distance parameter D of each infrared lamp bead as the second distance parameter between each infrared lamp bead and the infrared camera. Finally, the VR head-mounted device calculates the average value of the second distance parameters, and marks the result of the average value as the first distance parameter between the handle and the VR head-mounted device.

Step S40: converting the first distance parameter into the spatial coordinates of the handle to position and track the handle.

In this embodiment, the terminal device uses the above-mentioned first distance parameter as depth information, and at the same time converts the first distance parameter into the spatial coordinates of the above-mentioned handle in the 3D world presented by the terminal device according to the algorithm preset by the user, and then continuously updates the spatial coordinates by the terminal device according to the position change of the handle.

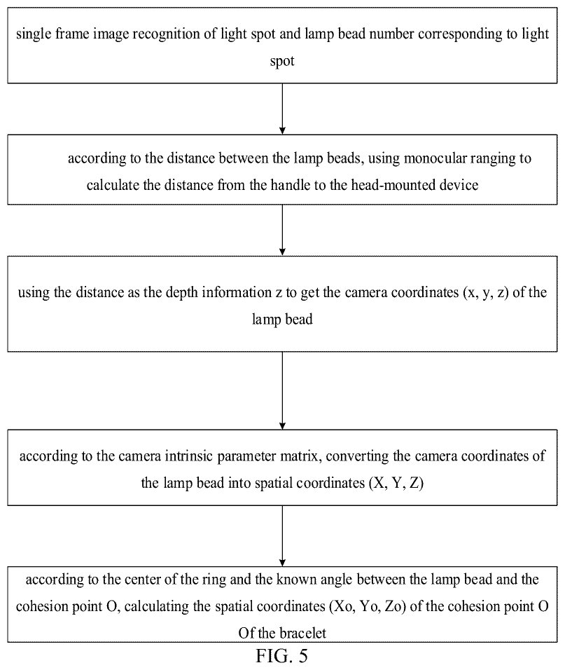

For example, please referring to FIG. 5, after the VR head-mounted device calculates the distance between the handle and the VR head-mounted device, it marks the distance between the handle and the VR head-mounted device as depth information. At the same time, the VR head-mounted device calculates the pixel coordinates of each light spot in the above image through the computer vision algorithm preset by the user. After that, the VR head-mounted device combines the pixel coordinates with the depth information, and through the computer vision algorithm, obtains the camera coordinates of the target infrared lamp beads corresponding to the light spot among the multiple infrared lamp beads. Subsequently, the VR head-mounted device calculates and converts the internal parameter matrix formula preset by the infrared camera into the respective spatial coordinates of the infrared lamp beads in the above-mentioned 3D world. Finally, the VR head-mounted device, in combination with the user's preset cohesion point of the handle, converts the spatial coordinates of each target infrared lamp bead into the spatial coordinate of the cohesion point in the 3D world so as to be used as the spatial coordinates of the handle. The VR head-mounted device continuously updates the spatial coordinates of the handle according to the position of the handle.

It should be noted that, in this embodiment, the camera internal parameter matrix formula is:

$$\\ {Z}_{C} = [ \begin{matrix}U \\ V \\ 1\end{matrix} ] = [ \begin{matrix}{f}_{x} & 0 & {c}_{x} \\ 0 & {f}_{y} & {c}_{y} \\ 0 & 0 & 1\end{matrix} ] [ \begin{matrix}{X}_{C} \\ {Y}_{C} \\ {Z}_{C}\end{matrix} ] = {KP}_{c}$$

Further, in a feasible embodiment, the above step S40 may specifically include:

Step S401: determining the first coordinates of each of the plurality of target light sources relative to the image acquisition device;

In this embodiment, the terminal device calculates the pixel coordinates of each light spot in the above-mentioned image according to the algorithm preset by the user, and uses the above-mentioned first distance parameter as the depth information. The terminal device combines the above-mentioned pixel coordinates and the depth information to calculate according to the algorithm preset by the user to determine the first coordinates of each of the above-mentioned target light sources relative to the image acquisition device.

Step S402: converting the plurality of first coordinates into the second coordinates of each of the plurality of target light sources in the 3D space; the 3D space is the 3D space displayed by the VR head-mounted device;

In this embodiment, the terminal device combines the first coordinates with the internal parameter matrix formula preset by the image acquisition device to calculate the spatial coordinates of each of the multiple target light sources in the 3D space presented by the terminal device. The spatial coordinates are marked as the second coordinates.

Step S403: converting the plurality of second coordinates into third coordinates of the handle's cohesion point in the 3D space, and using the third coordinates as the spatial coordinates of the handle in the 3D space.

In this embodiment, the terminal device combines the above-mentioned second coordinates with the user's preset position of the handle's cohesion point, converts into the third coordinate of the cohesion point in the above-mentioned 3D space, and determines the third coordinate as spatial coordinate of the handle in the above 3D space.

For example, please referring to FIG. 5, the VR head-mounted device calculates the pixel coordinates (x, y) of each light spot in the above image according to the computer vision algorithm preset by the user, and the VR head-mounted device uses the first distance parameter as the depth information z. Combined with the respective pixel coordinates of each light spot in the image, the VR head-mounted device calculates according to the computer vision algorithm preset by the user to obtain the respective camera coordinates (x, y, z) of each target infrared lamp bead relative to the infrared camera, and marks the camera coordinates as the first coordinates. After that, the VR head-mounted device combines the multiple first coordinates with the above-mentioned internal parameter matrix formula preset by the infrared camera to calculate the respective spatial coordinates (X, Y, Z) of each target infrared lamp bead in the 3D world presented by the VR head-mounted device, and mark the spatial coordinate as second coordinate. Finally, the VR head-mounted device combines the plurality of second coordinates with the user's preset cohesion point in the handle, converts it into the handle's spatial coordinates (Xo, Yo, Zo) in the above-mentioned 3D space, and marks the spatial coordinates as the third coordinate. The VR head-mounted device changes the position of the handle by updating the third coordinate, so as to complete the tracking of the position of the handle.

In this embodiment, firstly, when the terminal device is running, multiple light sources configured on the handle matched with the terminal device each emit invisible light, and the terminal device captures images including multiple light spots generated by the multiple light sources emitting invisible light on the handle through the built-in image acquisition device. Then, the terminal device recognizes the characteristic data of each of the multiple light spots in the above image, retrieves the action data generated by the handle during movement, combines the characteristic data with the action data, and compares the combined data with the light spot characteristic data in the preset offline characteristic database to determine the identification data of the target light sources corresponding to the multiple light spots in the image among the multiple light sources. And then, the terminal device determines the positional relationship between the target light sources according to the first identification data of the target light sources corresponding to the plurality of light spots and the arrangement rules preset by the user; and then the terminal device calculates the first distance parameter between the handle and the terminal device through the user's preset algorithm in combination with the position relationship. Finally, the terminal device uses the first distance parameter as the depth information; and at the same time, the terminal device converts the first distance parameter to the spatial coordinates of the above-mentioned handle in the 3D world presented by the terminal device according to the algorithm preset by the user; and then the terminal device continuously updates the spatial coordinates according to the position change of the handle.

Compared with the tracking method of the handle in the existing VR head-mounted device, the present application, by obtaining the infrared rays emitted by different infrared light source devices set on the handle, calculates the distance from the different infrared light source devices to the camera, and then converts the distance into the spatial coordinates of the handle in the 3D world presented by the VR head-mounted device, so as to achieve the effect of positioning and tracking the handle with high positioning accuracy and high refresh rate, thereby improving the user's experience when using the VR head-mounted device.

Further, the present application also provides a device for positioning and tracking. Please referring to FIG. 7, FIG. 7 is a functional module schematic diagram of the device for positioning and tracking according to an embodiment of the present application. As shown in FIG. 7, the device for positioning and tracking of the present application includes:

An acquisition module, configured for capturing an image containing a plurality of light spots through the image acquisition device; the plurality of light spots are generated by multiple light sources on the handle each emitting invisible light;

A determination module, configured to determine the identification data of the target light sources corresponding to the plurality of light spots in the image in the multiple light sources;

A calculation module, configured to determine the positional relationship between a plurality of target light sources according to the first identification data, and calculate the distance parameter between the handle and the VR head-mounted device according to the positional relationship;

A conversion module, configured to convert the distance parameter into the spatial coordinates of the handle to position and track the handle.

Further, the determination module includes:

Detection and acquisition unit: configured to detect the characteristic data of each of the plurality of light spots, and obtain the action data of the handle;

Combination comparison unit: configured to combine multiple characteristic data and action data to obtain combined data, and compare multiple combined data with spot characteristic data in a preset offline characteristic database to obtain a comparison result;

Determination unit: configured to determine the first identification data of the target light source corresponding to each of the plurality of light spots in the multiple light sources according to the comparison result.

Further, the determination module also includes:

Determination similarity unit: configured to determine, if the comparison result is that the combined data is similar to the light spot characteristic data, the second identification data of each of the multiple light sources associated with the light spot characteristic data as the first identification data of the target light source corresponding to the plurality of the light spots.

Further, the determination module also includes:

Image acquisition unit: configured to capture a second image containing a plurality of light spots through the image acquisition device during the movement of the handle when performing any action;

Construction unit: configured to combine the characteristic data of the plurality of light spots in the second image with the action data generated during the movement of the handle to build the offline characteristic database.

Further, the calculation module includes:

Acquisition unit: configured to obtain the arrangement rules;

Determination unit: configured to determine the positional relationship of the target light sources corresponding to the plurality of light spots in the multiple light sources according to the arrangement rules;

Furthermore, the calculation module also includes:

Calculation unit: configured to calculate the second distance parameter between each of the plurality of target light sources and the image acquisition device through the position relationship;

Average unit: configured to calculate the average value of a plurality of second distance parameters, so as to use the calculated average value as the first distance parameter between the handle and the VR head-mounted device.

Further, the conversion module includes:

A first coordinate determination unit: configured to determine the first coordinates of each of the plurality of target light sources relative to the image acquisition device;

A second coordinate conversion unit: configured to convert a plurality of the first coordinates into a plurality of second coordinates of each of the target light sources in the 3D space; the 3D space is the 3D space displayed by the VR head-mounted device;

A third coordinate conversion unit: configured to convert a plurality of the second coordinates into the third coordinates of the handle's cohesion point in the 3D space, and use the third coordinates as spatial coordinates of the handle in the 3D space.

The present application also provides a terminal device, which has a positioning and tracking program that can be run on a processor. When the terminal device executes the positioning and tracking program, it implements the step of the method for positioning and tracking as described in any of the above embodiments.

The specific embodiments of the terminal device of the present application are basically the same as the above embodiments of the method for positioning and tracking, and will not be described again here.

The present application also provides a computer-readable storage medium. The computer-readable storage medium stores a positioning and tracking program. When the positioning and tracking program is executed by a processor, the step of the method for positioning and tracking as described in any of the above embodiments is implemented.

The specific embodiments of the computer-readable storage medium of the present invention are basically the same as the embodiments of the method for positioning and tracking, and will not be described in detail here.

It should be noted that, as used herein, the terms “include”, “comprise” or any other variation thereof are intended to cover a non-exclusive inclusion, such that a process, method, article or system that includes a list of elements not only includes those elements, but also includes other elements not expressly listed or that are inherent to the process, method, article or system. Without further limitation, an element defined by the statement “comprises a . . . ” does not exclude the presence of other identical elements in the process, method, article, or system that includes that element.

The above serial numbers of the embodiments of the present application are only for description and do not represent the advantages or disadvantages of the embodiments.

Through the above description of the embodiments, those skilled in the art can clearly understand that the methods of the above embodiments can be implemented by means of software plus the necessary general hardware platform. Of course, it can also be implemented by hardware, but in many cases the former is a better implementation. Based on this understanding, the technical solution of the present application can be embodied in the form of a software product that contributes to the existing technology. The computer software product is stored in a storage medium (such as ROM/RAM, magnetic disk, optical disk) as mentioned above, including several instructions to cause a terminal device (which can be a mobile phone, computer, server, or network device, etc.) to execute the methods described in various embodiments of the present application.

The above are only some embodiments of the present application, and are not intended to limit the patent scope of the present application. Any equivalent structure or equivalent process transformation made using the contents of the description and drawings of the present application, or directly or indirectly used in other related technical fields, are all equally included in the patent protection scope of the present application.

Each embodiment in this specification is described in a parallel or progressive manner. Each embodiment focuses on its differences from other embodiments. The same or similar parts between the various embodiments can be referred to each other. As for the device disclosed in the embodiment, since it corresponds to the method disclosed in the embodiment, the description is relatively simple. For relevant details, please referring to the description in the method section.

Those skilled in the art can also understand that, the units and algorithm steps of each example described in conjunction with the embodiments disclosed herein can be implemented with electronic hardware, computer software, or a combination of both. In order to clearly illustrate the interchangeability relationship between hardware and software, in the above description, the composition and steps of each example have been generally described according to functions. Whether these functions are performed in hardware or software depends on the specific application and design constraints of the technical solution. Those skilled in the art may implement the described functionality using different methods for each specific application, but such implementations should not be considered beyond the scope of the present application.

What is claimed is:

1. A method for positioning and tracking, wherein the method for positioning and tracking is applied to a virtual reality (VR) head-mounted device equipped with an image acquisition device to perform positioning and tracking of a handle, and the handle is equipped with multiple light sources; the method comprises:
capturing an image containing a plurality of light spots by the image acquisition device, wherein the plurality of light spots are generated by each of multiple light sources on the handle emitting invisible light;
determining first identification data of target light sources corresponding to the plurality of light spots in the image in the multiple light sources;
determining a positional relationship between a plurality of the target light sources according to the first identification data, and calculating a first distance parameter between the handle and the VR head-mounted device according to the positional relationship; and
converting the first distance parameter into a spatial coordinate of the handle to perform positioning and tracking of the handle.

2. The method for positioning and tracking according to claim 1, wherein the determining the first identification data of the target light sources corresponding to the plurality of light spots in the image in the multiple light sources comprises:
detecting characteristic data of each of the plurality of light spots, and obtaining action data of the handle;
combining multiple characteristic data and action data to obtain combined data, and compare multiple combined data with light spot characteristic data in a preset offline characteristic database to obtain a comparison result; and
determining the first identification data of the target light source corresponding to each of the plurality of light spots in the multiple light sources according to the comparison result.

3. The method for positioning and tracking according to claim 2, wherein the determining the first identification data of the target light source corresponding to each of the plurality of light spots in the multiple light sources according to the comparison result comprises:
in response to that the comparison result is that the combined data is similar to the light spot characteristic data, then determining the second identification data of each of the multiple light sources associated with the light spot characteristic data as the first identification data of the target light source corresponding to each of the multiple light spots.

4. The method for positioning and tracking according to claim 2, further comprising:
in response to that the handle performs any action and moves, capturing a second image containing the plurality of light spots by the image acquisition device; and
constructing the offline characteristic database by combining the characteristic data of the plurality of light spots in the second image with the action data generated during a movement of the handle.

5. The method for positioning and tracking according to claim 1, wherein the light sources are arranged on the handle according to preset arrangement rules, and the determining the positional relationship between the plurality of the target light sources according to the first identification data comprises:
obtaining the arrangement rules; and
determining the positional relationship of the target light sources corresponding to the plurality of light spots respectively in the multiple light sources according to the arrangement rules.

6. The method for positioning and tracking according to claim 1, wherein the calculating the first distance parameter between the handle and the VR head-mounted device according to the positional relationship comprises:
calculating a second distance parameter between each of the plurality of target light sources and the image acquisition device based on the positional relationship; and
calculating an average value for a plurality of second distance parameters, and configuring a calculated average value as the first distance parameter between the handle and the VR head-mounted device.

7. The method for positioning and tracking according to claim 1, wherein the converting the first distance parameter into the spatial coordinate of the handle to perform positioning and tracking of the handle comprises:
determining first coordinates of each of the plurality of target light sources relative to the image acquisition device;
converting a plurality of first coordinates into the second coordinates of each of the plurality of target light sources in 3D space, wherein the 3D space is the 3D space displayed by the VR head-mounted device; and
converting a plurality of second coordinates into third coordinates of a cohesion point of the handle in the 3D space, and configuring the third coordinates as spatial coordinates of the handle in the 3D space.

8. An apparatus for positioning and tracking, comprising:
an acquisition module, configured to capture an image containing a plurality of light spots through an image acquisition device, wherein the plurality of light spots are generated by each of multiple light sources emitting invisible light on a handle;
a determination module, configured to determine first identification data of target light sources corresponding to the plurality of light spots in the image in the multiple light sources;
a calculation module, configured to determine a positional relationship between a plurality of target light sources according to the first identification data, and calculate a first distance parameter between the handle and a VR head-mounted device according to the positional relationship; and
a conversion module, configured to convert the first distance parameter into a spatial coordinate of the handle to position and track the handle.

9. A terminal device, comprising: a memory, a processor, and a positioning and tracking program stored on the memory and executable on the processor; the positioning and tracking program is configured to implement the steps of the method for positioning and tracking according to claim 1.

10. A computer-readable storage medium, wherein a positioning and tracking program is stored on the computer-readable storage medium; when the positioning and tracking program is executed by a processor, the steps of the method for positioning and tracking according to claim 1 are implemented.
